(19) United States
(12) Patent Application Publication
(10) Pub. No.: US 2017/0098391 A1
(43) Pub. Date: Apr. 6, 2017

(54) LEARNING CARD

(71) Applicant: TSUI-CHHIUNG WU, Pingtung City (TW)

(72) Inventor: TSUI-CHHIUNG WU, Pingtung City (TW)

(21) Appl. No.: 14/876,451

(22) Filed: Oct. 6, 2015

(51) Int. Cl. G09B 23/02

(52) U.S. Cl. CPC G09B 23/02

(57) ABSTRACT

A learning card includes a background area located at an area thereof, a number area located inside the background area for displaying a specific number, a geometric-figure area located inside the background area for providing at least one geometric figures to match the specific number, a sentence-making area located inside the background area for displaying a sentence to match the specific number, a figure area located at another area thereof for displaying a figure to match the sentence provided in the sentence-making area and the specific number in the number area.

### BACKGROUND OF INVENTION

1. Field of the Invention

The invention relates to a learning card, and more particularly to a whole set of the learning cards that use different colors to help children to learn numbers, simultaneously educate children about classifications, and also provide various geometric figures, Chinese sentence-making and related figures such as action figures.

2. Description of the Prior Art

Conventional number learning for children is usually performed by the parents or specific childhood education centers by utilizing relevant books, teaching materials or simply verbal interpretations. In particular, while a book is used as the major teaching material, since the book usually has a finite volume, so the accompanying portability of the book becomes a problem, and thereby the number education for children can't be performed anywhere and anytime. Further, besides the number education, it is well understood that the educations in colors, geometric figures or Chinese are also important parts for childhood educations.

To resolve the aforesaid shortcomings, a teaching material with a limited size convenient for the parents or relatives to educate the children is definitely welcome for both education and entertainment purposes.

### SUMMARY OF THE INVENTION

Accordingly, it is the primary object of the present invention to provide a learning card and a set of these learning cards that can introduce different colors to help children in learning numbers, simultaneously to educate children about classifications, and also to provide various geometric figures, Chinese sentence-making and related figures such as action figures. By providing the learning cards of the present invention, parents and relatives can perform the childhood education anytime and anywhere, and more particularly the child on its-own card play can quickly learn and memory the numbers by correlations of the figures and the characters and also by a stimulus from direct voicing.

In the present invention, the learning card includes:

a background area, located at one area of the learning card;

a number area, located inside the background area for displaying a specific number;

a geometric-figure area, located inside the background area for displaying at least one geometric figure to match the specific number;

a sentence-making area, located inside the background area for displaying a sentence to match the specific number;

a figure area, located at another area of the learning card for displaying a related figure to match the sentence-making area;

a membrane switch, located on a surface of the background area, the number area being printed on the membrane switch;

a voice IC, located at an inner layer of the learning card, electrically coupled with the membrane switch, the voice IC storing voice data for the sentence-making area;

a speaker, located at the inner layer of the learning card, electrically coupled with the voice IC for playing the voice data; and

a battery, located at the inner layer of the learning card, electrically coupled with and thus energizing the membrane switch, the voice IC and the speaker.

Preferably, the background area can display a color selected from the group of a red color, a blue color, a green color and an orange color.

Preferably, a shape of the at least one geometric figure can be one of a triangle, a circle, a rectangle and a star.

Preferably, the number area can display an integral number ranged from 1 to 10.

Preferably, the figure area can be an action figure (a people image) for a user of the learning card to learn the sentence provided in the sentence-making area and the specific number shown in the number area.

Preferably, the learning card can be shaped as a rectangle to be present in a paper card manner and to be conveniently stored in a paper box.

Preferably, the surface of the learning card that does not have the figure area includes a magnetic member able to be adhered onto an attachment board made of a metallic material, such that the learning card can be fixed to a surface of the attachment board in an adhesive manner.

All these objects are achieved by the learning card described below.

### BRIEF DESCRIPTION OF THE DRAWINGS

The present invention will now be specified with reference to its preferred embodiment illustrated in the drawings, in which:

FIG. 1 shows schematically an arrangement of a whole set of learning cards in accordance with the present invention;

FIG. 2 is a schematic view of a first embodiment of the learning card in accordance with the present invention;

FIG. 3 is a schematic view of a second embodiment of the learning card in accordance with the present invention;

FIG. 4 demonstrates various embodiments of sentences for a sentence-making area of the learning card in accordance with the present invention;

FIG. 5 presents a schematic lateral view of a magnetic member mounted to a back of the learning card in accordance with the present invention;

FIG. 6 demonstrates a schematic view of two learning cards of the present invention being adhered to an attachment board; and

FIG. 7 is a schematic view of a voice circuit for the learning card in accordance with the present invention.

### DESCRIPTION OF THE PREFERRED EMBODIMENT

The invention disclosed herein is directed to a learning card. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

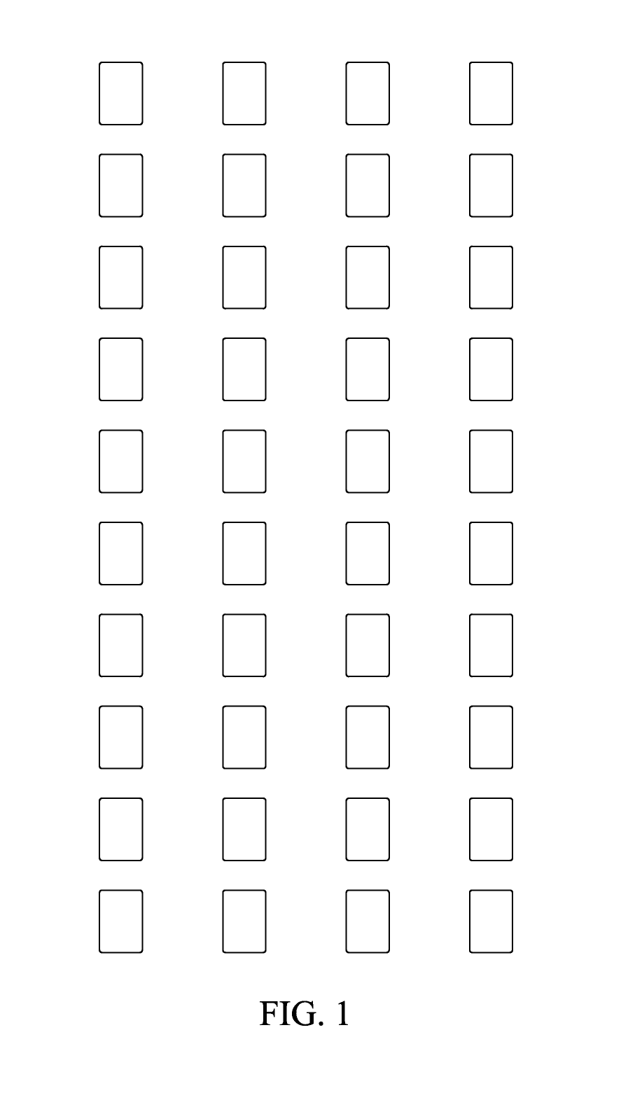

Referring now to FIG. 1, an arrangement of a whole set of learning cards in accordance with the present invention is shown schematically. In this arrangement, 40 learning cards (4×10), typically but not limited thereto, are included. Each of the learning cards has a shape of rectangle, is (but not limited to) colored into four color groups (red, blue, green and orange), and has an individual integral number ranged from 1 to 10. Upon such an arrangement, the set of the learning cards can be helpful to number-learning for children and also to educate the children about classification by colors. By providing the 40 learning cards to be present in a paper card manner and to be conveniently stored in a paper box, well portability for the learning cards can be achieved.

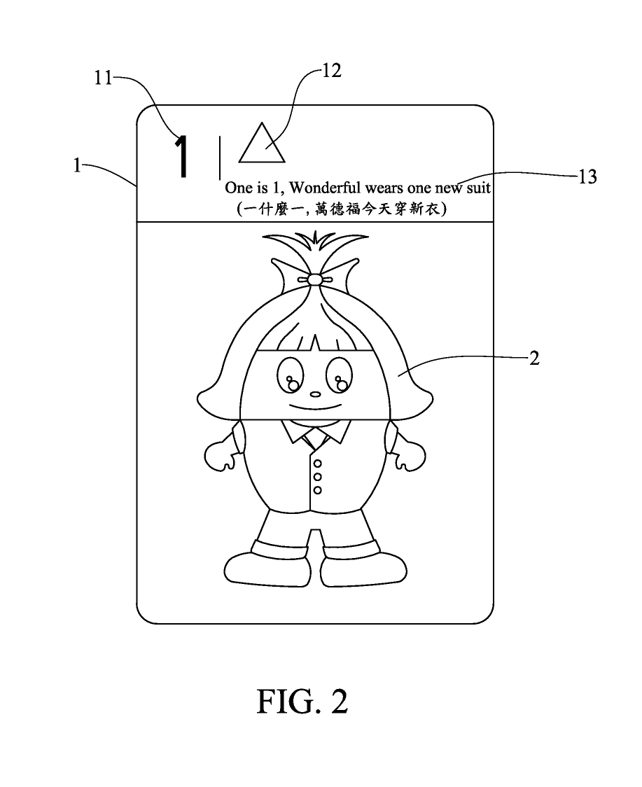

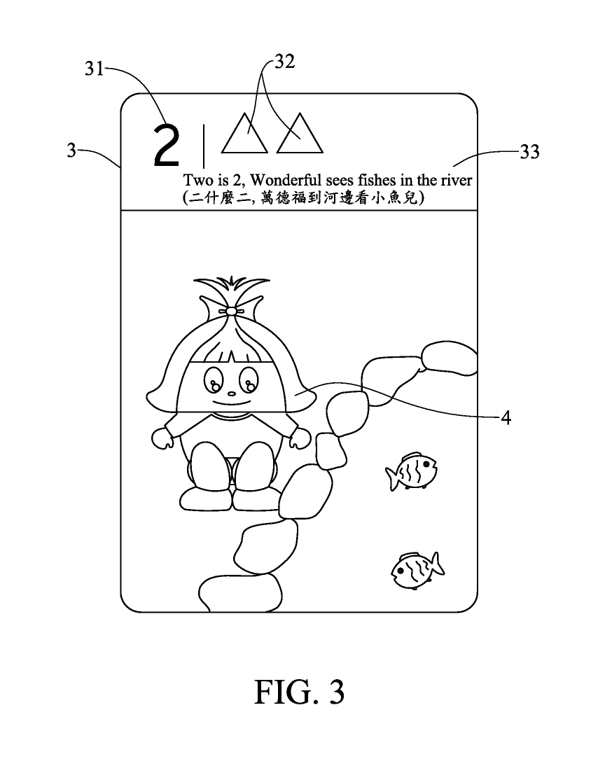

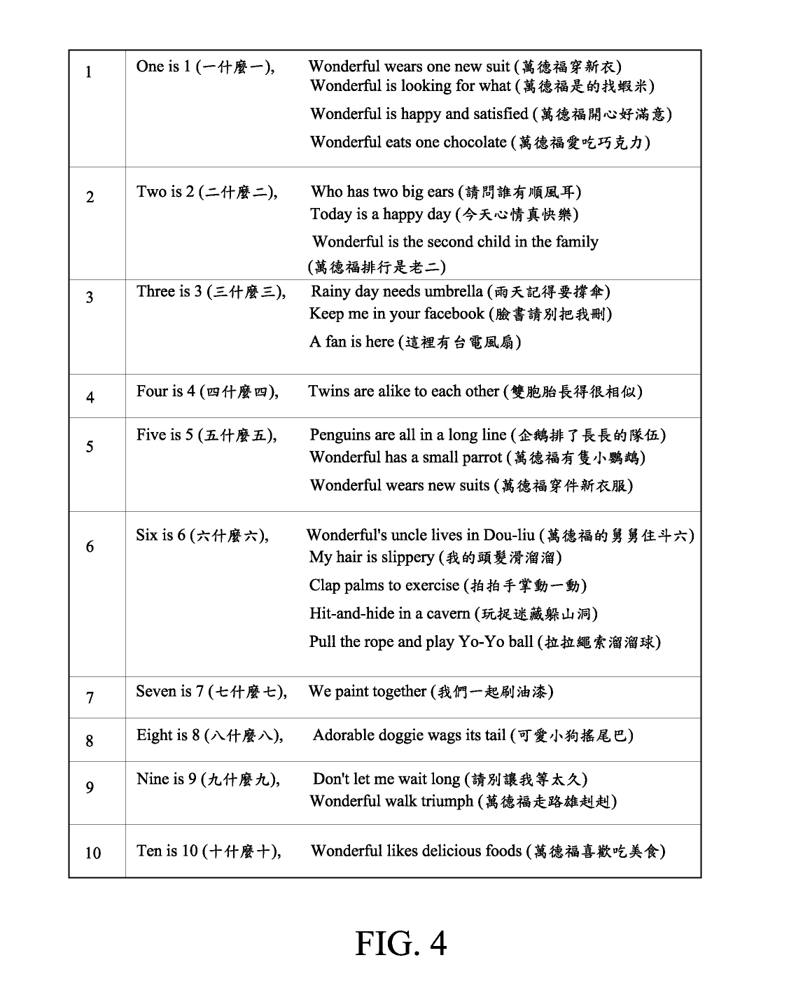

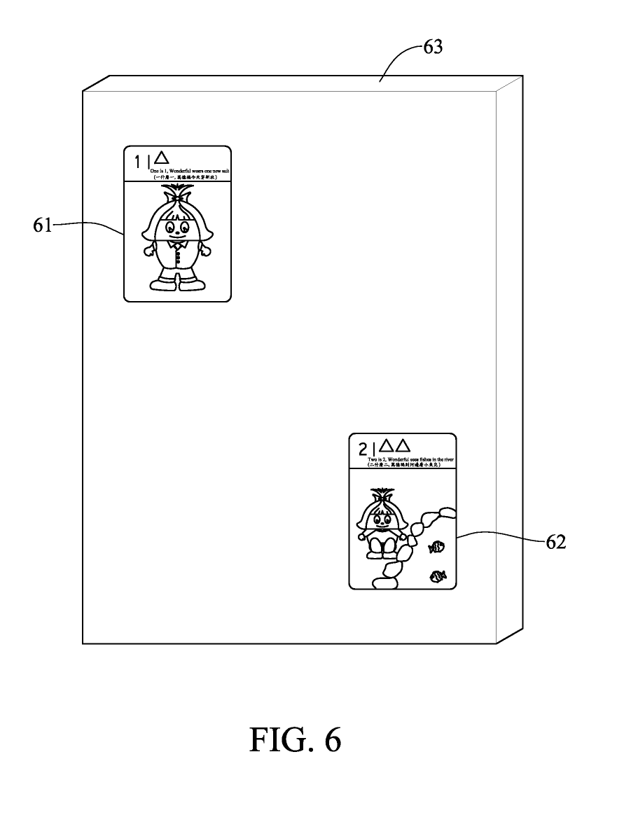

Please note that, in FIG. 2, FIG. 3, FIG. 4 and FIG. 6, direct literal translation from Chinese phrases as originally filed in Taiwan to corresponding phrases in English is presented. It shall be emphasized that these original Chinese words in the Taiwan application are meaningful and rhyme to meet the object of the present invention if they are read in Mandarin (though does not rhyme in English).

Referring now to FIG. 2 and FIG. 3, a first embodiment and a second embodiment of the learning card in accordance with the present invention are schematically shown, respectively. In these two embodiments, the learning card includes a background area (1, 3), a number area (11, 31), a geometric-figure area (12, 32) and a sentence-making area (13, 33), respectively (labeling for the first embodiment and the second embodiment). The background area (1, 3) colored to be red, blue, green or orange is located at one area of the learning card. The number area (11, 31) is located inside the background area (1, 3) for displaying a specific number. The geometric-figure area (12, 32) is located inside the background area (1, 3) for displaying at least one geometric figure (one shown in the figure) to match the specific number, in which the geometric figure can have a shaped selected from the group of a triangle, a circle, a rectangle and a star. These geometric figures in the geometric-figure area (12, 32) are accompanied in number to educate the specific number shown in the number area (11, 31). For example, as shown in FIG. 2 where a number “2” is shown in the number area (31), then two geometric figures triangularly shaped are provided in the geometric-figure area (32) to match the number “2” shown in the number area 31. The sentence-making area (13, 33) located also inside the background area (1, 3) is to display a sentence in meaning to match the specific number shown in the figure area (11, 31). The figure area (2, 4) located at another area (lower area shown in the figure) of the learning card is to display a related figure to match the sentence provided in the sentence-making area (13, 33). As shown in FIG. 2 or FIG. 3, the respective figure area (2, 4) is to display an action figure (a people image), and thus a user of the learning card can apply the sentence in the sentence-making area (13, 33) to match a possible story told by the figure shown in the figure area (2, 4).

Referring now to FIG. 4, various embodiments of sentences for the sentence-making area of the learning card in accordance with the present invention are demonstrated. In the sentence-making area (13, 33), a number from 1 to 10 can be provided, and the correlated sentence to the provided number in the sentence-making area (13, 33) can be any but with correlated meaning to match thereto. Importantly, the sentence provided in the sentence-making area (13, 33) is not definitely limited, but shall only meet a requirement that the sentence shall help the children to memory by correlating in meaning to the specific number provided in the number area (11, 31). Upon such an arrangement, the purpose of teaching the children to memory the number can be achieved.

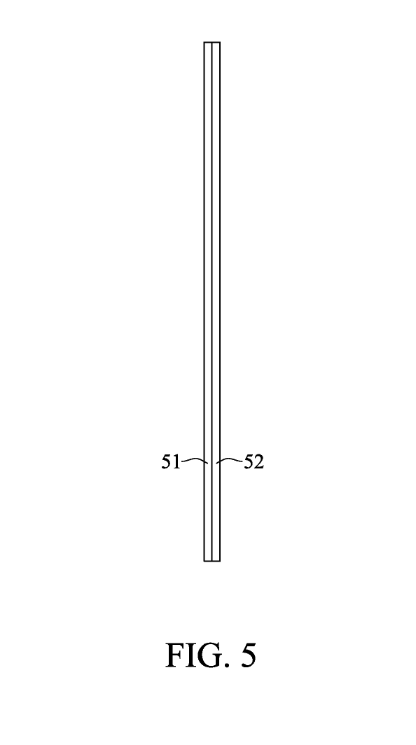

Refer now to FIG. 5 and FIG. 6, in which FIG. 5 presents a schematic lateral view of a magnetic member mounted to a back of the learning card in accordance with the present invention, and FIG demonstrates a schematic view of two learning cards of the present invention being adhered to an attachment board. As shown, the surface of the learning card 51 that does not include the figure area (2, 4) has a magnetic member 52. The magnetic member 52 is to pair the metal-made attachment board 63 of FIG. 6 for forming a comprehensive adhering pair. Namely, the learning card (61, 62) can be adhered to a surface of the attachment board 63, so that the children can read and learn the number directly on the attachment board 63.

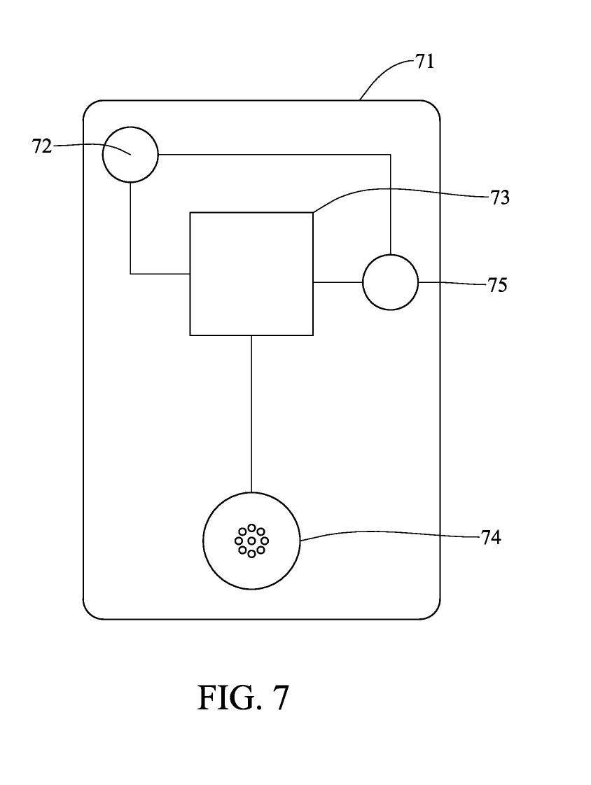

Referring now to FIG. 7, a schematic view of a voice circuit for the learning card in accordance with the present invention is shown. The voice circuit includes a membrane switch 72, a voice IC 73, a speaker 74 and a battery 75. The membrane switch 72 is located in the aforesaid background area 1 of FIG. 2 with the number area 11 to be printed thereon (not shown in the figure). Upon such an arrangement, the basic surface arrangement of the learning card 71 can be maintained, and the circuit can be switched on/off to initiate/end the voice function of the learning card 71 by simply depressing at the membrane switch 72 right under the number area 11. The voice IC 73 is located in an inner layer of the learning card 71 and is electrically coupled with the membrane switch 72. The voice IC 73 can store voice data for the sentences to be presented in the sentence-making area of FIG. 4. The speaker 74 located also at the inner layer of the learning card 71 is electrically coupled with the voice IC 73 so as to broadcast the corresponding voice data through the speaker 74. The battery 75 located at the inner layer of the learning card 71 is electrically coupled with and thus energizing the membrane switch 72, the voice IC 73 and the speaker 74. By providing the aforesaid voice circuit, the children can easily depress the membrane switch 71 to initiate a voice function to have the voice IC 73 to “speak” the sentence provided in the sentence-making area (13, 33), such that the children can learn the number and the vocabulary in the sentence by direct sight and hearing.

By providing the disclosure of FIG. 1 through FIG. 7, it is well understood that the learning card of the present invention is mainly to provide a single learning card and a whole set of such learning cards that can introduce different colors to help children in learning numbers, simultaneously to educate children about classifications (specifically in colors), and also to provide various geometric figures, Chinese sentence-making and related figures such as action figures. By providing the learning cards of the present invention, parents and relatives can perform the childhood education anytime and anywhere, and more particularly the child on its-own card play can quickly learn and memory the numbers by correlations of the figures and the characters and also by a stimulus from direct voicing. Such a product is definitely welcome to the industry of childhood educations and also has a considerable commercial value.

While the present invention has been particularly shown and described with reference to a preferred embodiment, it will be understood by those skilled in the art that various changes in form and detail may be without departing from the spirit and scope of the present invention.

What is claimed is:

1. A learning card, comprising:
a background area, located at one area of the learning card;
a number area, located inside the background area for displaying a specific number;
a geometric-figure area, located inside the background area for displaying at least one geometric figure to match the specific number;
a sentence-making area, located inside the background area for displaying a sentence to match the specific number;
a figure area, located at another area of the learning card for displaying a related figure to match the sentence provided in the sentence-making area and the specific number provided in the number area;
a membrane switch, located on a surface of the background area, the number area being printed on the membrane switch;
a voice IC, located at an inner layer of the learning card, electrically coupled with the membrane switch, the voice IC storing voice data for the sentence-making area;
a speaker, located at the inner layer of the learning card, electrically coupled with the voice IC for playing the voice data; and
a battery, located at the inner layer of the learning card, electrically coupled with and thus energizing the membrane switch, the voice IC and the speaker.

2. The learning card of claim 1, wherein the background area displays a color selected from the group of a red color, a blue color, a green color and an orange color.

3. The learning card of claim 1, wherein a shape of the at least one geometric figure is one of a triangle, a circle, a rectangle and a star.

4. The learning card of claim 1, wherein the number area displays an integral number ranged from 1 to 10.

5. The learning card of claim 1, wherein the figure area is an action figure (a people image) for a user of the learning card to learn by matching the sentence provided in the sentence-making area.

6. The learning card of claim 1, wherein the learning card is shaped as a rectangle to be present in a paper card manner and to be conveniently stored in a paper box.

7. The learning card of claim 1, wherein a surface of the learning card that does not have the figure area includes a magnetic member able to be adhered onto an attachment board made of a metallic material, such that the learning card is able to be fixed to a surface of the attachment board in an adhesive manner.
